(19) United States
(12) Patent Application Publication
(10) Pub. No.: US 2026/0029096 A1
(43) Pub. Date: Jan. 29, 2026

(54) LAMP WITH HYBRID CONNECTOR AND LAMP ASSEMBLY HAVING THE SAME

(71) Applicant: Xiamen PVTECH Co., Ltd., Xiamen (CN)

(72) Inventors: FUXING LU, Xiamen (CN); XIAOPING LAN, Xiamen (CN); DEJIA LI, Xiamen (CN)

(21) Appl. No.: 19/344,441

(22) Filed: Sep. 29, 2025

Related U.S. Application Data
(63) Continuation-in-part of application No. 17/751,607, filed on May 23, 2022, now Pat. No. 12,455,069.

(51) Int. Cl. F21S 2/00; F21V 19/00; F21V 23/06; H01R 13/03; H01R 13/28; H01R 33/76

(52) U.S. Cl. CPC F21S 2/005; F21V 19/009; F21V 23/06; H01R 13/03; H01R 13/28; H01R 33/7657

(57) ABSTRACT

A lamp with hybrid connector is provided, which includes a lamp tube and two lamp caps. The lamp caps are disposed at the two ends of the lamp tube respectively. Each of the lamp caps includes an end surface, four first connection structures and four second connection structure. The end surface has an upper area and a lower area defined by a horizontal line. The upper area has a first central point and the lower area has a second central point. Two of the four connection structures are disposed on the upper area. The other of the first connection structures are disposed on the lower area. Two of the second connection structures are disposed on the upper area. The other of the second connection structures are disposed on the lower area. The first connection structures and the second connection structures are mirror-symmetrical.

### TECHNICAL FIELD

The present invention relates to a lamp capable of connecting to another lamp in series, in particular to a lamp having a symmetrical structure.

### BACKGROUND

Lamps are frequently-used products in people's daily lives. A lamp usually includes a light cover, a light source, a power source, a reflector, a diffuser plate, etc.

In some applications, it may be necessary to connect several lamps with each other in series, which may cause the increase of the manufacturing cost of these lamps. Besides, these lamps may be hard to be connected in series because of the design of the connection structure thereof. The above problems may influence the application range or the sales status of theses lamps. Therefore, it has become an important issue to solve to above problems.

### SUMMARY

To achieve the foregoing objective, one embodiment of the present invention provides a lamp with hybrid connector, which includes a lamp tube and two lamp caps. The lamp caps are disposed at the two ends of the lamp tube. Each of the lamp caps includes an end surface, two first connection structures and two second connection structures.

The end surface has a central point. The first connection structures are disposed on the end surface and arranged to be symmetrical, about the central point, to each other. The second connection structures are disposed on the end surface and corresponding to the first connection structures. The second connection structures are arranged to be symmetrical, about the central point, to each other.

Another embodiment of the present invention further provides a lamp with hybrid connector, which includes a lamp tube and two lamp caps. The lamp caps are disposed at the two ends of the lamp tube. Each of the lamp caps includes an end surface, four first connection structures and four second connection structures.

The end surface has an upper area and a lower area defined by a horizontal line. The upper area has a first central point and the lower area has a second central point. Two of the four connection structures are disposed on the upper area and arranged to be symmetrical, about the first central point, to each other. The other of the first connection structures are disposed on the lower area and arranged to be symmetrical, about the second central point, to each other. Two of the second connection structures are disposed on the upper area and arranged to be symmetrical, about the first central point, to each other. The other of the second connection structures are disposed on the lower area and arranged to be symmetrical, about the second central point, to each other. The first connection structures and the second connection structures disposed on the upper area are mirror-symmetrical, about the horizontal line, to the first connection structures and the second connection structures disposed on the lower area.

In this embodiment, each of the first connection structures includes a top surface, a connection hole and a conductive post. The connection hole is formed on the top surface and the conductive post is disposed in the connection hole. Each of the second connection structures includes a slot and a conductive tube element. The slot is formed on the end surface and the conductive tube element is disposed in the slot.

Still another embodiment of the present invention further provides a lamp assembly, which includes at least two lamps with hybrid connector and the lamps are connected to each other in series. Each of the lamps includes a lamp tube and two lamp caps. The lamp caps are disposed at the two ends of the lamp tube. Each of the lamp caps includes an end surface, two first connection structures and two second connection structures.

The end surface has a central point. The first connection structures are disposed on the end surface and arranged to be symmetrical, about the central point, to each other. The second connection structures are disposed on the end surface and corresponding to the first connection structures. The second connection structures are arranged to be symmetrical, about the central point, to each other.

Still another embodiment of the present invention further provides a lamp assembly, which includes at least two lamps with hybrid connector and the lamps are connected to each other in series. The lamp caps are disposed at the two ends of the lamp tube. Each of the lamp caps includes an end surface, four first connection structures and four second connection structures.

The end surface has an upper area and a lower area defined by a horizontal line. The upper area has a first central point and the lower area has a second central point. Two of the four connection structures are disposed on the upper area and arranged to be symmetrical, about the first central point, to each other. The other of the first connection structures are disposed on the lower area and arranged to be symmetrical, about the second central point, to each other. Two of the second connection structures are disposed on the upper area and arranged to be symmetrical, about the first central point, to each other. The other of the second connection structures are disposed on the lower area and arranged to be symmetrical, about the second central point, to each other. The first connection structures and the second connection structures disposed on the upper area are mirror-symmetrical, about the horizontal line, to the first connection structures and the second connection structures disposed on the lower area.

In this embodiment, each of the first connection structures includes a top surface, a connection hole and a conductive post. The connection hole is formed on the top surface and the conductive post is disposed in the connection hole. Each of the second connection structures includes a slot and a conductive tube element. The slot is formed on the end surface and the conductive tube element is disposed in the slot.

To sum up, according to the lamp with hybrid connector disclosed in one embodiment of the present invention, since the each of the lamp caps disposed at the two ends of the lamp tube has a symmetrical connection structure, any one of the two ends of the lamp tube can be connected to another lamp tube in series, which is more convenient in use. Besides, according to the lamp with hybrid connector disclosed in one embodiment of the present invention, as each of the lamp caps disposed at the two ends of the lamp tube has the symmetrical connection structure, the manufacturing cost of the lamp with hybrid connector can be less than that of currently available lamps, which can effectively achieve the sales growth of the lamp with hybrid connector.

Further scope of applicability of the present application will become more apparent from the detailed description given hereinafter. However, it should be understood that the detailed description and specific examples, while indicating exemplary embodiments of the present invention, are given by way of illustration only, since various changes and modifications within the spirit and scope of the present invention will become apparent to those skilled in the art from this detailed description.

### BRIEF DESCRIPTION OF DRAWINGS

The present invention will become more fully understood from the detailed description given herein below and the accompanying drawings which are given by way of illustration only, and thus are not limitative of the present invention and wherein:

FIG. 1 is a partially exploded view of a lamp with hybrid connector in accordance with one embodiment of the present invention.

FIG. 2 is a front view of the lamp with hybrid connector shown in FIG. 1.

FIG. 3 is a partially structural view of the lamp with hybrid connector shown in FIG. 1, which shows the two ends of the lamp.

FIG. 4 is a schematic view of use of a lamp assembly in accordance with one embodiment of the present invention.

FIG. 5 is a partially exploded view of a lamp with hybrid connector in accordance with one embodiment of the present invention.

FIG. 6 is a front view of the lamp with hybrid connector shown in FIG. 5.

FIG. 7 is a partially structural view of the lamp with hybrid connector shown in FIG. 5, which shows the two ends of the lamp.

FIG. 8 is a schematic view of use of a lamp assembly in accordance with one embodiment of the present invention.

FIG. 9 is a perspective view of an inner connection element of a lamp tube connector with hybrid connection structure in accordance with one embodiment of the present invention.

FIG. 10 is a perspective view of an outer tube body of the lamp tube connector with hybrid connection structure in accordance with one embodiment of the present invention.

FIG. 11 is a first exploded view of the lamp tube connector with hybrid connection structure according to one embodiment of the present invention.

FIG. 12 is a second exploded view of the lamp tube connector with hybrid connection structure in accordance with one embodiment of the present invention.

FIG. 13 is an assembled view of a lamp tube connector with hybrid connection structure in accordance with one embodiment of the present invention.

FIG. 14 is a first assembled view of a lamp assembly in accordance with one embodiment of the present invention.

FIG. 15 is a second assembled view of a lamp assembly in accordance with one embodiment of the present invention.

### DETAILED DESCRIPTION

The technical content of the present invention will become apparent by the detailed description of the following embodiments and the illustration of related drawings as follows.

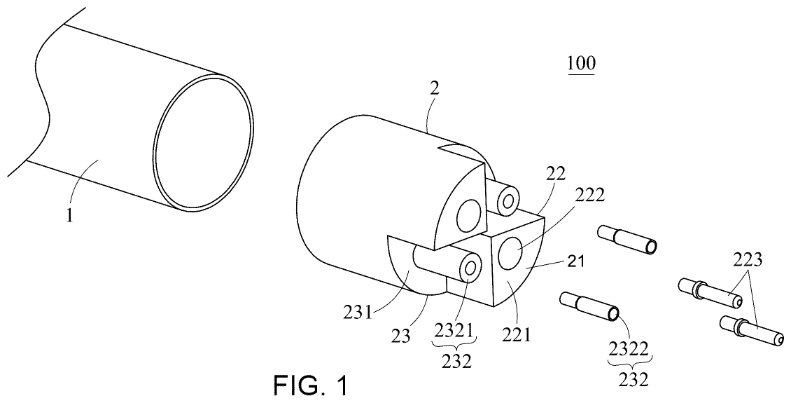

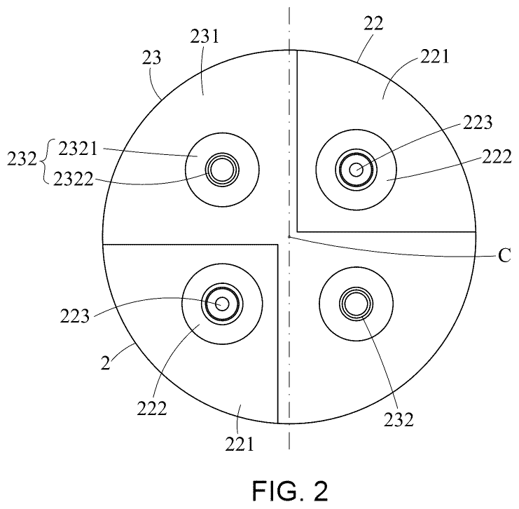

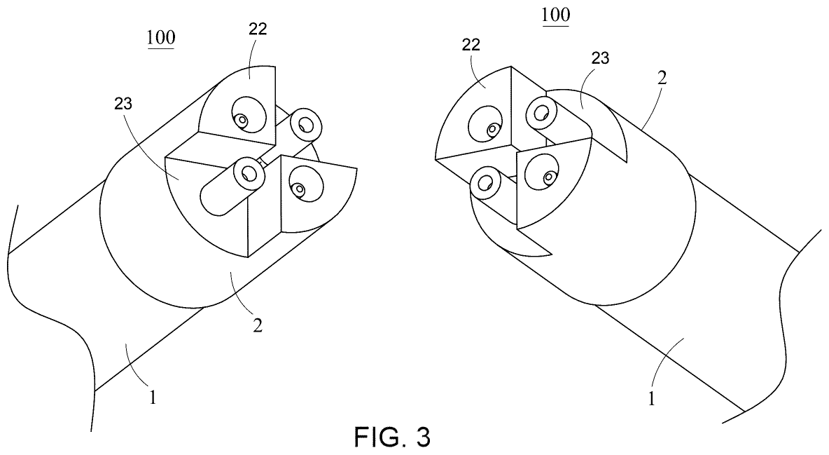

Please refer to FIG. 1, FIG. 2 and FIG. 3. FIG. 1 is a partially exploded view of a lamp 100 with hybrid connector in accordance with one embodiment of the present invention. FIG. 2 is a front view of the lamp 100 with hybrid connector shown in FIG. 1. FIG. 3 is a partially structural view of the lamp 100 with hybrid connector shown in FIG. 1, which shows the two ends of the lamp 100.

The lamp 100 with hybrid connector includes a lamp tube 1 and two lamp caps 2. The lamp caps 2 are disposed at the two ends of the lamp tube 1. Each of the lamp caps 2 includes an end surface 21, two first connection structures 22 and two second connection structures 23.

The end surface 21 has a central point C. The first connection structures 22 are disposed on the end surface 21. The first connection structures 22 are arranged to be symmetrical, about the central point C, to each other. As described above, the first connection structures 22 are arranged to be in point symmetry. That is to say, after rotating about the central point C clockwise or counterclockwise for 180°, one of the first connection structures 22 can overlap the other of the first connection structures 22. The two second connection structures 23 are disposed on the end surface 21 and corresponding to the two first connection structures 22. The second connection structures 23 are arranged to be symmetrical, about the central point C, to each other (in point symmetry).

As shown in FIG. 1˜FIG. 3, the first connection structure 22 includes a top surface 221, a connection hole 222 and a conductive post 223. The connection hole 222 is formed on the top surface 221 and the conductive post 223 is disposed in the connection hole 222. The second connection structure 23 includes a slot 231 and a conductive tube element 232. The slot 231 is formed on the end surface 21 and the conductive tube element 232 is disposed in the slot 231. In this embodiment, the conductive tube element 232 includes a conductive tube 2321 and a conductive sleeve 2322, and the conductive sleeve 2322 is disposed in the conductive tube 2321. In one embodiment, the conductive post 223 is a copper post. In one embodiment, the material of the conductive tube 2321 is the same with that of the lamp cap 2 and the conductive sleeve 2322 is a copper sleeve.

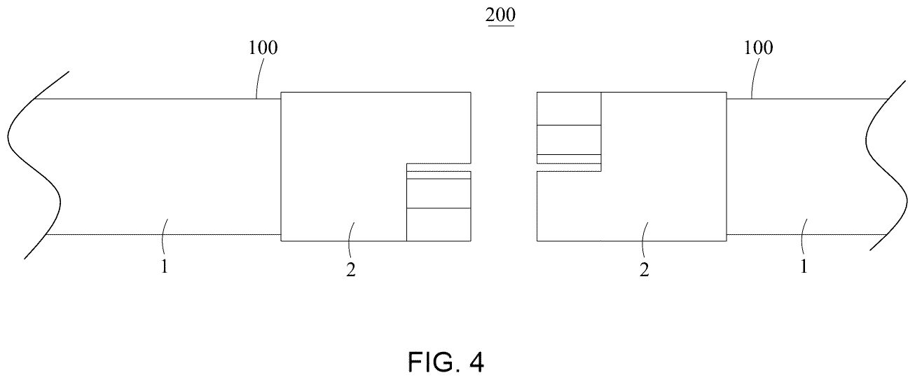

Please refer to FIG. 4, which is a schematic view of use of a lamp assembly in accordance with one embodiment of the present invention. The lamp assembly 200 includes at least two lamps 100 with hybrid connector shown in FIG. 3. The lamps 200 with hybrid connector are connected to each other in series. Via this structure, the user can easily replace any one of the lamps 100. That is to say, any one of the two ends of the lamp 100 can be connected to another lamp 100, which can significantly reduce the time of assembling the lamp assembly 200. This structure can also effectively reduce the manufacturing cost of the lamp 100.

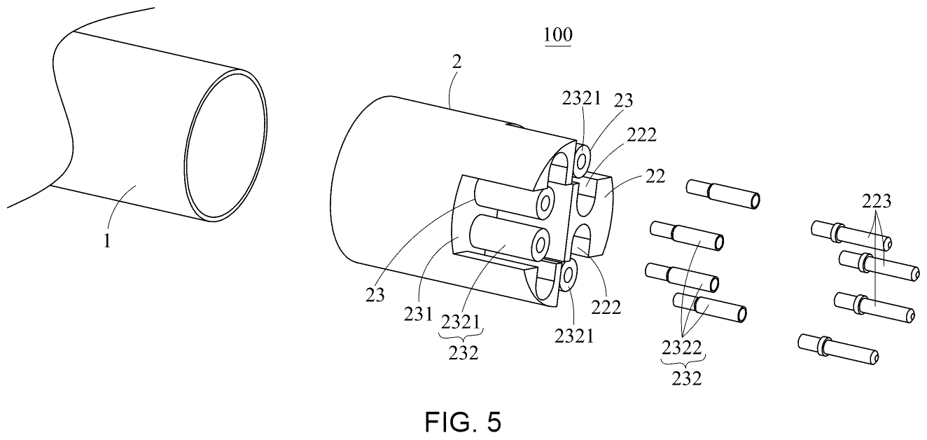

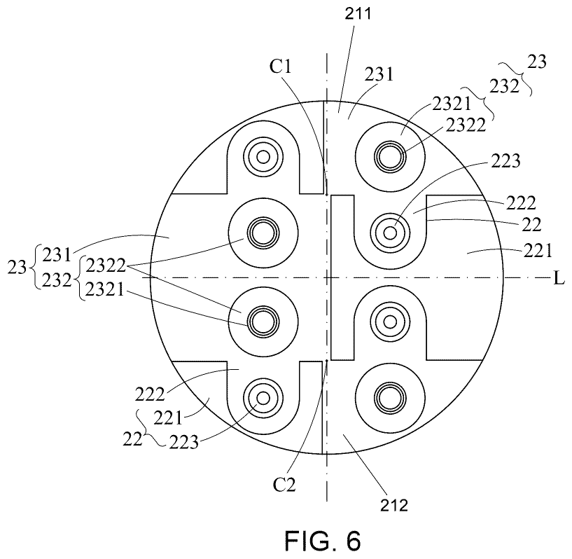

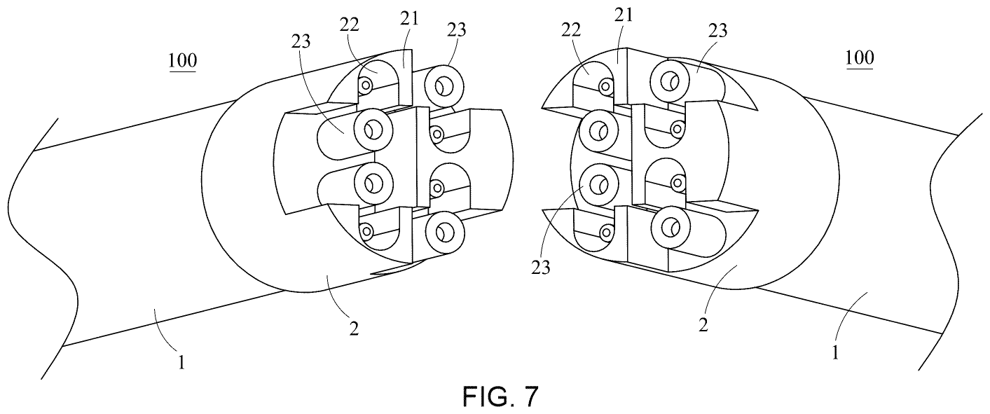

Please refer to FIG. 5, FIG. 6 and FIG. 7. FIG. 5 is a partially exploded view of a lamp 100 with hybrid connector in accordance with one embodiment of the present invention. FIG. 6 is a front view of the lamp 100 with hybrid connector shown in FIG. 5. FIG. 7 is a partially structural view of the lamp 100 with hybrid connector shown in FIG. 5, which shows the two ends of the lamp 100.

As shown in FIG. 5˜FIG. 7, the lamp 100 with hybrid connector includes a lamp tube 1 and two lamp caps 2. The lamp caps 2 are disposed at the two ends of the lamp tube 1. Each of the lamp caps 2 includes an end surface 21, four first connection structures 22 and four second connection structures 23. The end surface 21 has an upper area 211 and a lower area 212 defined by a horizontal line L. The upper area 211 has a first central point C1 and the lower area 212 has a second central point C2. Two of the four connection structures 22 are disposed on the upper area 211 and arranged to be symmetrical, about the first central point C1, to each other (in point symmetry). The other of the first connection structures 22 are disposed on the lower area 212 and arranged to be symmetrical, about the second central point C2, to each other (in point symmetry). Two of the second connection structures 23 are disposed on the upper area 211 and arranged to be symmetrical, about the first central point C1, to each other (in point symmetry). The other of the second connection structures 23 are disposed on the lower area 212 and arranged to be symmetrical, about the second central point C2, to each other (in point symmetry). The first connection structures 22 and the second connection structures 23 disposed on the upper area 211 are mirror-symmetrical, about the horizontal line L, to the first connection structures 22 and the second connection structures 23 disposed on the lower area 212. As set forth above, the first connection structures 22 and the second connection structures 23 disposed on the upper area 211 and the lower area 212 are in mirror symmetry. That is to say, after the end surface 21 are folded along the horizontal line L, the first connection structures 22 on the upper area 211 can overlap the first connection structures 22 on the lower area 212, and the second connection structures 23 on the upper area 211 can also overlap the second connection structures 23 on the lower area 212.

The detailed structures of the first connection structures 22 and the second connection structures 23 have been described in the previous embodiment, so will not be described herein again.

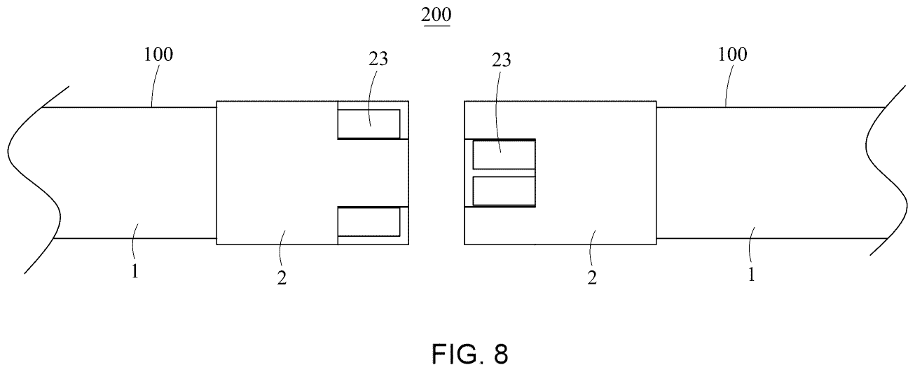

Please refer to FIG. 8, which is a schematic view of use of a lamp assembly in accordance with one embodiment of the present invention. The lamp assembly 200 includes at least two lamps 100 with hybrid connector shown in FIG. 7. The lamps 200 with hybrid connector are connected to each other in series. Via this structure, the user can easily replace any one of the lamps 100. In other words, any one of the two ends of the lamp 100 can be connected to another lamp 100, which can significantly reduce the time of assembling the lamp assembly 200. This structure can also effectively reduce the manufacturing cost of the lamp 100.

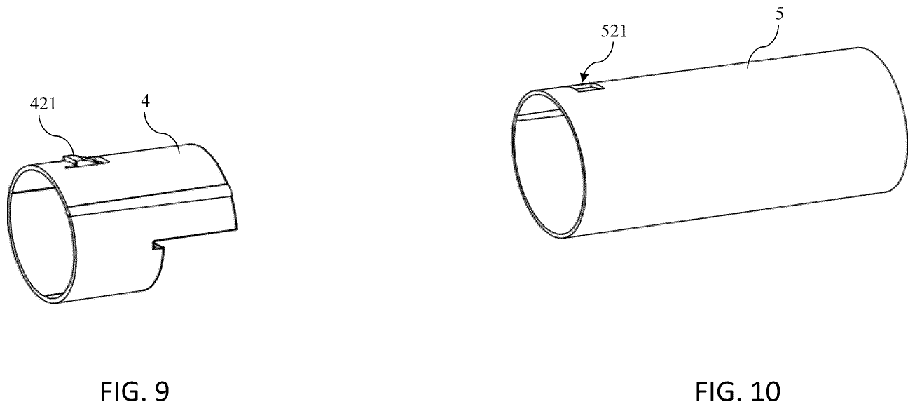

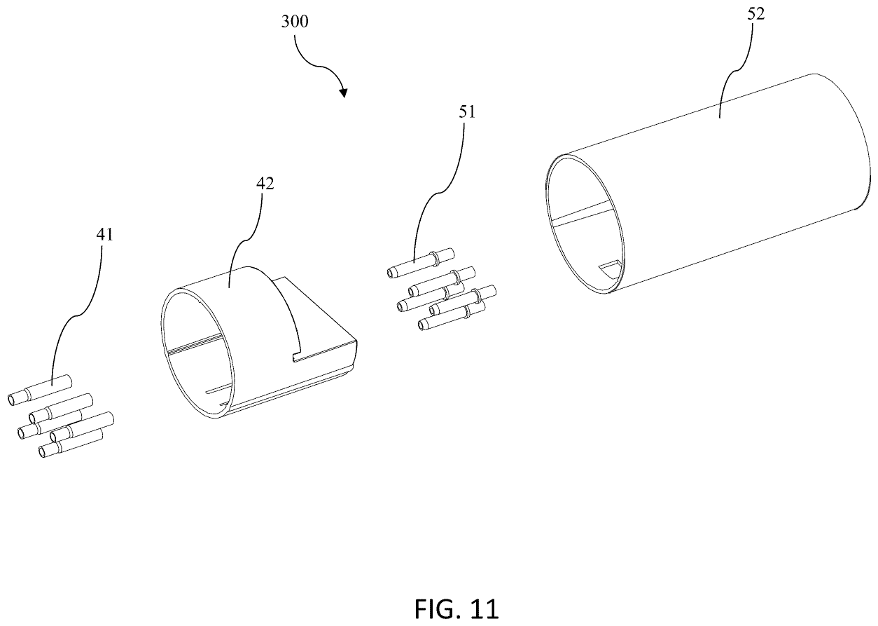

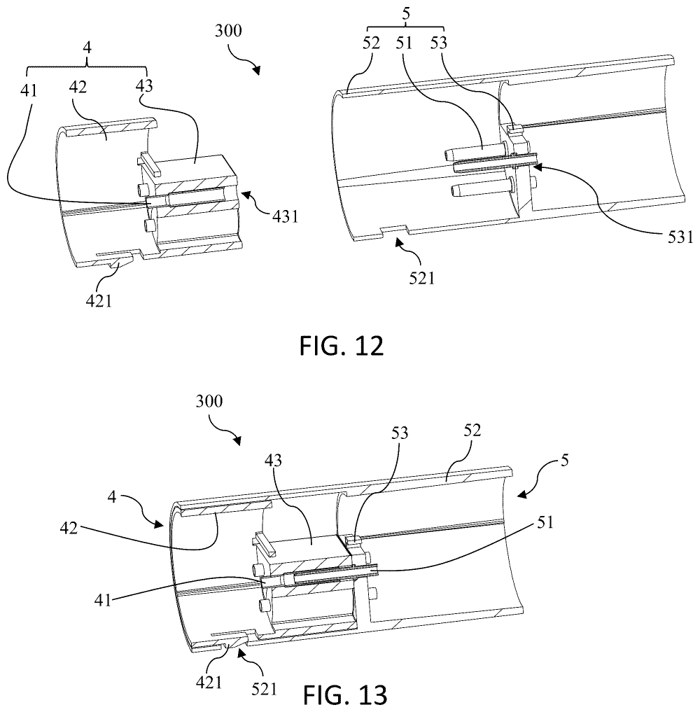

Please refer to FIG. 9, FIG. 10, FIG. 11, and FIG. 12. FIG. 9 is a perspective view of an inner connection element of a lamp tube connector with hybrid connection structure in accordance with one embodiment of the present invention. FIG. 10 is a perspective view of an outer tube body of the lamp tube connector with hybrid connection structure in accordance with one embodiment of the present invention. FIG. 11 is a first exploded view of the lamp tube connector with hybrid connection structure in accordance with one embodiment of the present invention. FIG. 12 is a second exploded view of the lamp tube connector with hybrid connection structure in accordance with one embodiment of the present invention (presented in a cross-sectional manner). As shown in FIG. 9, FIG. 10, FIG. 11, and FIG. 12, the lamp tube connector 300 includes an inner connection element 4 and an outer tube body 5.

The inner connection element 4 includes a plurality of conductive sleeves 41, an inner tube portion 42 and a conductive sleeve installation portion 43. In the embodiment, the quantity of the conductive sleeves 41 is 5, which is just for illustration; the quantity of the conductive sleeves 41 can be changed according to actual needs (for example, the quantity of the conductive sleeves 41 may be 4, 6 or more than 6). The inner tube portion 42 is connected to the conductive sleeve installation portion 43. The outer surface of the inner tube portion 42 is provided with a fastener 421. The conductive sleeve installation portion 43 has a plurality of conductive sleeve installation holes 431, which are corresponding to the conductive sleeves 41 respectively, such that the conductive sleeves 41 can be inserted in to the conductive sleeve installation holes 431 respectively. In one embodiment, the fastener 421 is locking hook. In another embodiment, the fastener 421 may be a protrusion or other similar components. In one embodiment the conductive sleeves 41 may be copper sleeves.

The outer tube body 5 includes a plurality of conductive posts 51, a housing 52 and a conductive post installation portion 53. In the embodiment, the quantity of the conductive posts 51 is 5, which is just for illustration; the quantity of the conductive posts 51 can be changed according to actual needs (for example, the quantity of the conductive posts 51 may be 4, 6 or more than 6). The conductive post installation portion 53 is disposed in the housing 52. The conductive post installation portion 53 has a plurality of conductive post installation holes 531, which are corresponding to the conductive posts 51, such that the conductive posts 51 can be inserted into the conductive post installation holes 531 respectively. The housing 52 is provided with a fastening hole 521, which is corresponding to the fastener 421 of the inner tube portion 42. The position of the conductive post installation portion 53 is corresponding to that of the conductive sleeve installation portion 43, so the positions of the conductive post installation holes 531 are also corresponding to the positions of the conductive sleeve installation holes 431 respectively. In one embodiment the conductive posts 51 may be copper posts.

The embodiment just exemplifies the disclosure and is not intended to limit the scope of the disclosure; any equivalent modification and variation according to the spirit of the disclosure is to be also included within the scope of the following claims and their equivalents.

Please refer to FIG. 13, which is an assembled view of a lamp tube connector with hybrid connection structure in accordance with one embodiment of the present invention (presented in a cross-sectional manner). As shown in FIG. 13, when the inner connection element 4 is combined with the outer tube body 5, the fastener 421 can be engaged with the fastening hole 521, such that the inner connection element 4 can be inserted into the outer tube body 5, and the inner connection element 4 can be fixed with the outer tube body 5. Besides, the inner connection element 4 is not exposed from the outer tube body 5.

As the positions of the conductive post installation holes 531 are corresponding to the positions of the conductive sleeve installation holes 431 respectively, the conductive posts 51 can be inserted into the conductive sleeves 41 respectively after the inner connection element 4 is combined with the outer tube body 5.

The embodiment just exemplifies the disclosure and is not intended to limit the scope of the disclosure; any equivalent modification and variation according to the spirit of the disclosure is to be also included within the scope of the following claims and their equivalents.

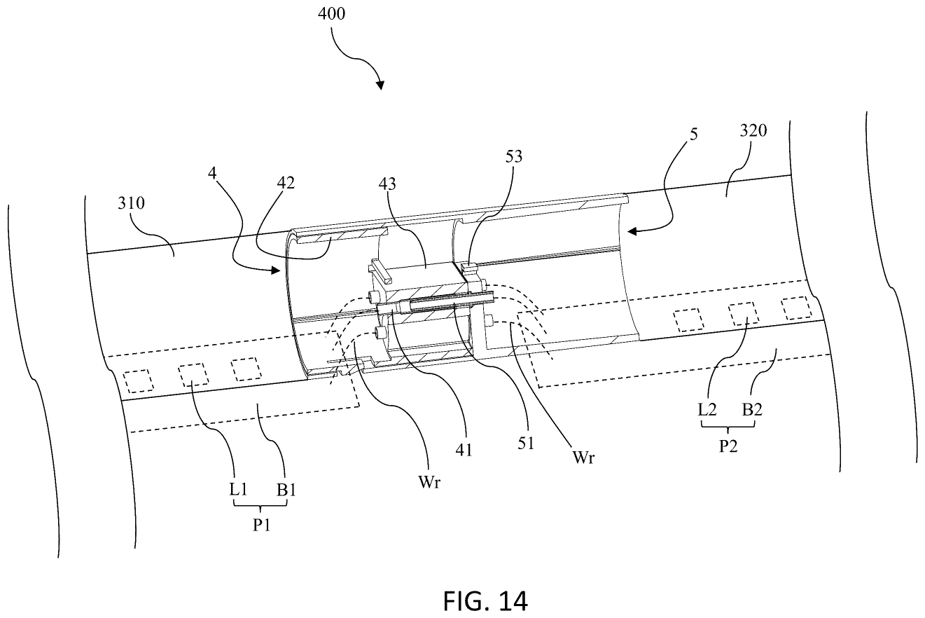

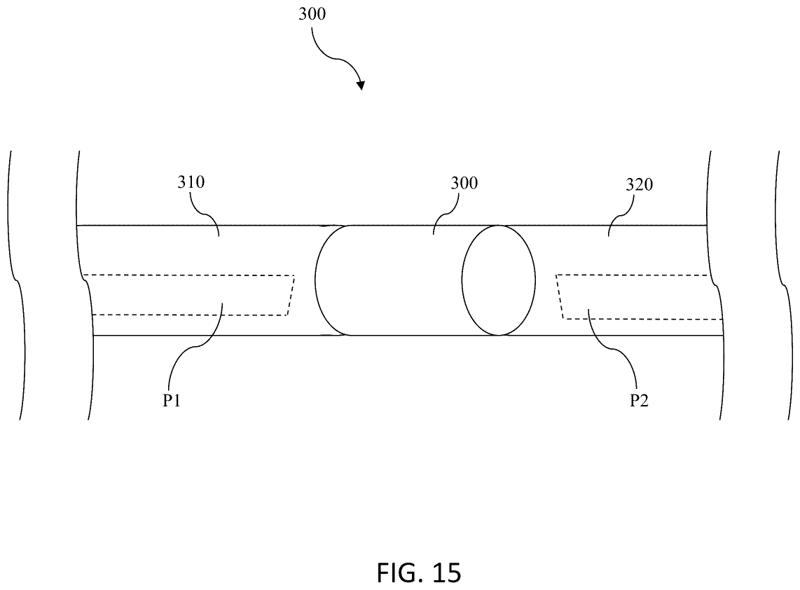

Please refer to FIG. 14 and FIG. 15. FIG. 14 is a first assembled view of a lamp assembly in accordance with one embodiment of the present invention (presented in a cross-sectional manner). FIG. 15 is a second assembled view of a lamp assembly in accordance with one embodiment of the present invention. As shown in FIG. 14 and FIG. 15, the lamp assembly 400 includes the above lamp tube connector 300, a first lamp tube 310 and a second lamp tube 320.

One end of the first lamp tube 310 can be inserted into the inner connection element 4, and one end of the second lamp tube 320 can be inserted into the outer tube body 5, such that the first lamp tube 310 and the second lamp tube 320 can be fixed at the two ends of the lamp tube connector 300. The first lamp tube 310 and the second lamp tube 320 can be fixed at the two ends of the lamp tube connector 300 by other ways.

The first lamp tube 310 includes a first light source board P1. The first light source board P1 includes a first circuit board B1 and a plurality of first light-emitting diodes L1 disposed on the first circuit board B1. The first circuit board B1 is electrically connected to the first light-emitting diodes L1. The first light source board P1 is disposed inside the first lamp tube 310 and is connected to the conductive sleeves 41 via a plurality of wires Wr.

The second lamp tube 320 includes a second light source board P2. The second light source board P2 includes a second circuit board B2 and a plurality of second light-emitting diodes L2 disposed on the second circuit board B2. The second circuit board B2 is electrically connected to the second light-emitting diodes L2. The second light source board P2 is disposed inside the second lamp tube 320 and is connected to the conductive posts 51 via a plurality of wires Wr.

In this way, after the inner connection element 4 is combined with the outer tube body 5, the first lamp tube 310 and the second lamp tube 320 can be electrically connected to each other via the conductive sleeves 41 and the conductive posts 51. The lamp assembly 400 can further include a power supply disposed in the first lamp tube 310 or the second lamp tube 320. The lamp assembly 400 can be electrically connected to an external power source. For instance, the lamp assembly 400 can be installed on a lamp tube base (or other similar components), and electrically connected to the external power source via the lamp tube base. The lamp assembly 400 can be also directly and electrically connected to the external power source. In another embodiment, the lamp assembly 400 can further include a plurality of power supplies disposed in the first lamp tube 310 and the second lamp tube 320 respectively. The external power source may be a utility power, an AC generator or other similar power sources.

Via the aforementioned hybrid connection structure including the inner connection element 4 and the outer tube body 5, the first lamp tube 310 and the second lamp tube 320 can be connected to each other in series and electrically connected to each other. Furthermore, during the production process, the first lamp tube 310 and the inner connection element 4 can be combined to form a first module, while the second lamp tube 320 and the outer tube body 5 can be combined to form a second module, thereby reducing the overall length by half. The length of the first module is approximately half the length of the lamp assembly 400, and the length of the second module is also approximately half the length of the lamp assembly 400, which can effectively reduce production costs. Additionally, the first module and the second module can be packaged separately to lower transportation costs.

The inner connection element 4 and the outer tube body 5 are easily miniaturized and do not obstruct the light emitted by the lamp assembly 400. Thus, the dark areas caused by the light of the lamp assembly 400 are significantly reduced, enhancing the illumination effect of the lamp assembly 400. Therefore, the performance of the lamp assembly 400 can be greatly improved to meet actual requirements.

Moreover, another outer tube body 5 can also be disposed at the other end of the first lamp tube 310, and another inner connection element 4 can also be disposed at the other end of the second lamp tube 320. In this way, the lamp assembly 400 can serially connect more lamp tubes to increase its total length. Consequently, the lamp assembly 400 can be more flexible in use so as to meet the requirements of different applications.

The embodiment just exemplifies the disclosure and is not intended to limit the scope of the disclosure; any equivalent modification and variation according to the spirit of the disclosure is to be also included within the scope of the following claims and their equivalents.

To sum up, according to the lamp with hybrid connector disclosed in one embodiment of the present invention, since the each of the lamp caps disposed at the two ends of the lamp tube has a symmetrical connection structure, any one of the two ends of the lamp tube can be connected to another lamp tube in series, which is more convenient in use. Besides, according to the lamp with hybrid connector disclosed in one embodiment of the present invention, as each of the lamp caps disposed at the two ends of the lamp tube has the symmetrical connection structure, the manufacturing cost of the lamp with hybrid connector can be less than that of currently available lamps, which can effectively achieve the sales growth of the lamp with hybrid connector.

It will be apparent to those skilled in the art that various modifications and variations can be made to the disclosed embodiments. It is intended that the specification and examples be considered as exemplary only, with a true scope of the present invention being indicated by the following claims and their equivalents.

What is claimed is:

1. A lamp with hybrid connector, comprising:
a lamp tube, and
two lamp caps, disposed at two ends of the lamp tube, wherein each of the lamp caps comprises:
an end surface, having an upper area and a lower area defined by a horizontal line, wherein the upper area has a first central point and the lower area has a second central point;
four first connection structures, wherein two of the four connection structures are disposed on the upper area and arranged to be symmetrical, about the first central point, to each other, and the other of the first connection structures are disposed on the lower area and arranged to be symmetrical, about the second central point, to each other; and
four second connection structures, wherein two of the second connection structures are disposed on the upper area and arranged to be symmetrical, about the first central point, to each other, and the other of the second connection structures are disposed on the lower area and arranged to be symmetrical, about the second central point, to each other;
wherein the first connection structures and the second connection structures disposed on the upper area are mirror-symmetrical, about the horizontal line, to the first connection structures and the second connection structures disposed on the lower area.

2. The lamp with hybrid connector as claimed in claim 1, wherein each of the first connection structures comprises a top surface, a connection hole and a conductive post, and the connection hole is formed on the top surface and the conductive post is disposed in the connection hole, wherein each of the second connection structures comprises a slot and a conductive tube element, the slot is formed on the end surface and the conductive tube element is disposed in the slot.

3. The lamp with hybrid connector as claimed in claim 2, wherein the conductive post is a copper post.

4. The lamp with hybrid connector as claimed in claim 2, wherein the conductive tube element comprises a conductive tube and a conductive sleeve, and the conductive sleeve is disposed in the conductive tube.

5. The lamp with hybrid connector as claimed in claim 4, wherein the conductive sleeve is a copper sleeve.

6. A lamp assembly, comprising at least two lamps with hybrid connector and the lamps are connected to each other in series, wherein each of the lamps comprises:
a lamp tube, and
two lamp caps, disposed at two ends of the lamp tube, wherein each of the lamp caps comprises:
an end surface, having an upper area and a lower area defined by a horizontal line, wherein the upper area has a first central point and the lower area has a second central point;
four first connection structures, wherein two of the four connection structures are disposed on the upper area and arranged to be symmetrical, about the first central point, to each other, and the other of the first connection structures are disposed on the lower area and arranged to be symmetrical, about the second central point, to each other; and
four second connection structures, wherein two of the second connection structures are disposed on the upper area and arranged to be symmetrical, about the first central point, to each other, and the other of the second connection structures are disposed on the lower area and arranged to be symmetrical, about the second central point, to each other;
wherein the first connection structures and the second connection structures disposed on the upper area are mirror-symmetrical, about the horizontal line, to the first connection structures and the second connection structures disposed on the lower area.

7. The lamp assembly as claimed in claim 6, wherein each of the first connection structures comprises a top surface, a connection hole and a conductive post, and the connection hole is formed on the top surface and the conductive post is disposed in the connection hole, wherein each of the second connection structures comprises a slot and a conductive tube element, the slot is formed on the end surface and the conductive tube element is disposed in the slot.

8. The lamp assembly as claimed in claim 7, wherein the conductive post is a copper post.

9. The lamp assembly as claimed in claim 7, wherein the conductive tube element comprises a conductive tube and a conductive sleeve, and the conductive sleeve is disposed in the conductive tube.

10. The lamp assembly as claimed in claim 9, wherein the conductive sleeve is a copper sleeve.
